(19) United States
(12) Patent Application Publication
(10) Pub. No.: US 2010/0073161 A1
(43) Pub. Date: Mar. 25, 2010

(54) Systems, Methods, and Computer Program for Monitoring Crime Activity and Dissemination of Crime Related Information and Alerts Over a Multi-User Network

(76) Inventor: Harry Engel, Palmdale, CA (US)

Correspondence Address: WHITE-WELKER & WELKER, LLC, P.O. BOX 199, CLEAR SPRING, MD, 21722-0199, US

(21) Appl. No.: 12/237,447

(22) Filed: Sep. 25, 2008

(51) Int. Cl. G08B 21/00

(52) U.S. Cl. 340/540

(57) ABSTRACT

A system and method that allows Law enforcement to communicate quickly and efficiently with businesses and business owners. Businesses first create a profile at a website. The profile includes address, contact information, secondary contact information, alarm company name and number and information about the type of business. Detectives have the ability to send email and electronic messages to electronic devices alerting businesses, their owners and their employees about crime that affects them. Detectives can select different types of businesses, businesses within a certain range or businesses that have certain characteristics, like handle a lot of cash. Additionally detectives have the ability to look up information about a specific business, for example at three AM when the window is broken, and they need someone to come take care of the mess, or retrieve information about a group of businesses, like the names and numbers of all pawn shops within five miles.

### FEDERALLY SPONSORED RESEARCH

Not Applicable

### SEQUENCE LISTING OR PROGRAM

Not Applicable

### CROSS REFERENCE TO RELATED APPLICATIONS

Not Applicable

### TECHNICAL FIELD OF THE INVENTION

The present invention relates generally to a crime alert system. More specifically, the present invention relates to a system that allows Law enforcement to communicate quickly and efficiently with businesses and business owners.

### BACKGROUND OF THE INVENTION

Today's multiple and diverse medias have made it impossible for local law enforcement to effectively and quickly communicate with businesses and business owners. As a result they do not have a method to warn businesses, groups, and individuals of issues that may affect their safety or the safety of the community.

Many businesses and residents are robbed by serial robbers. If it had been known there was a serial robber in the neighborhood, they could have taken proactive measures or with the knowledge of such activities could be more vigilant in their security measures. In a more recent matter, violence on college campuses, terrorists attacks, and school shootings have brought to light the need for target communication as it relates to criminal activity so the proactive and immediate action can be taken to protect from crime, protect or save victims of crime, or recover stolen property.

The prior art teaches several crime network features and system for law enforcement data management. For example, U.S. Patent Publication 20060184575 teaches a system of the present invention includes a server operable to communicate with the data access device carried in the law enforcement vehicle to request and display information about a person subject to investigation. This server is responsive to the data access device to retrieve a number of records corresponding to the person, provide a data arrangement that links a group of the records together and an identifier for such arrangement, and selectively accesses at least one member of the group of the records in response to an input from the data access device.

U.S. Pat. No. 6,870,906 teaches an emergency call system includes a data bus and bus controller operatively connected to the data bus for controlling data access on the data bus. The system can include at least one of wireless, direct connect and telephone subsystems. A wireless device module could be operatively connected to the data bus for receiving and passing alarm signals onto the data bus from a premises based wireless subsystem having at least one wireless receiver that receives wireless alarm signals from wireless pendants and other devices. The system could also include a direct connect module that receives and passes alarm signals onto the data bus from a premises based direct connect subsystem having wired stations and/or sensors. A telephone module could be operatively connected to the data bus for receiving alarm signals from a telephone of a residence through the telephone network and to the telephone module.

U.S. Patent Publication 20060092011 a number of different security systems, such as in home or business locations, periodically transmit status data to a remote facility such as a central monitoring station so that it is continuously informed of the security systems' status. The status may relate to an alarm status, armed status, or trouble code status. A user interface at the remote facility provides a spreadsheet format that allows a user to quickly ascertain the status of the security systems, and to send commands to the security systems. The security systems may be controlled individually or in groups, such as to add or delete authorizations. The user interface can filter or sort the information, or obtain further details. Other information, such as video and audio data from a security system, can also be provided to the remote facility for use in the user interface. Information can be recorded for subsequent playback.

U.S. Pat. No. 5,861,810 teaches a system and method for communicating information concerning the status of inmates to callers and automatically notify victims registered with the system at a registered electronic address when the status of a specified inmate has changed. The notifications to the electronic address of the registered victim will continue at spaced predetermined intervals until either the registered victim responds with a registered personal identification number or a predetermined time period measured from the initial time notification elapses.

U.S. Patent Publication 20060040639 discloses an alert system and apparatus for an emergency alert system is provided to disseminate emergency information to the public utilizing a universal paging system through a personal alert device such as a cellular telephone, pager, PDA or E-FOB. The alert system utilizes an emergency alert system signal from the NOAA alert system to broadcast the alert message to cellular devices in a specified alert area. The broadcast message provides information related to the alert level. The E-FOB may be a passive device that is activated by a NOAA alert signal and then listens for a cellular message. If the E-FOB is within the alert area, the E-FOB provides information to the user. If the E-FOB is not within the alert area, the E-FOB returns to a passive state.

U.S. Patent Publication 20060031582 teaches a system for inserting alert based information into broadcast programming over a program distribution network. A program distributor transmits broadcast programming over program distribution network via a network fabric. When program distributor receives alert based information, the program distributor converts the alert information from a first format to a second format compatible with the broadcast programming and the program distributor inserts the converted alert into a signal carrying the broadcast programming via the network fabric. A method is also disclosed for inserting alert based information into a broadcast programming transmitted over a program distribution network.

U.S. Patent Publication 20050151639 teaches a system for alerting the public regarding a criminal act; a plurality of law enforcements modes which generate alerts related to a criminal or emergency issue and transmit the same to a central server; a central server system including an administration workstation and database for receiving the alerts and creating broadcast messages; a broadcast system associated with the central server for broadcasting an alert via a televised broadcast, internet transmission or satellite transmission.

The Minnesota Crime Alert Network is a statewide communications network that enables law enforcement agencies to quickly alert the public about crime or criminals that may affect them. More than 7,200 Minnesota law enforcement agencies, businesses, schools, and community members participate in the Network, making it the nation's most unique and efficient network of communications between law enforcement agencies and the communities they serve.

As a crime happens that has the capacity of impacting anyone, anywhere, the FAX NET 1 crime alert program offers a fast, accurate way of getting the word out. They have the capacity of faxing and/or e-mailing any and all alerts to the designated locations that law enforcement feels necessary. Law enforcement sends a one page alert with: Only what the public needs to know to be good eyes and ears for the problem at hand, Law Enforcement Department name on top (logo preferred if available), Suspect names, a.k.a.(s) if applicable, physical description and distinguishing scars, tattoos, etc., Suspect pictures, if available, Pictures and descriptions of involved vehicles, if available, and Law Enforcement contact name and phone number.

The Crime Alert Network is a system for Redding area businesses that enables the Redding Police Department to notify you of frauds, crime patterns, stolen checks and other crimes to help you from becoming a victim. The information is faxed to a business, usually after 5:00 p.m.

The National Crime Alert Network is a network of Local Law Enforcement, Federal Agencies, Financial and Retail communities who participates in a Rapid Response notification network, providing “real time” information and intelligence of criminal activity and crimes within a given area which may effect one's business. If they can notify you quickly about a crime trend that may affect you or your business, you will have a better opportunity to take measures to protect yourself, your business, your employees, and your customers.

The National Crime Alert Network depends on the full participation and sharing of information from each Network member. Your information will be added to a secured database that can be used in the identification of a crime suspect and pursuing prosecution of the perpetrators of a crime. Not only will the real time information and intelligence help your financial institution or business concern, but will aid local law enforcement and federal agencies in a successful conviction.

Lack of communication on the part of our members is the number one obstacle in preventing losses due to fraud. The success and growth of the National Crime Alert Network is primarily due to open communication between all members of the network. The identity of the reporting business or financial institution is always kept confidential.

When information is received by the National Crime Alert Network, it is reviewed and screened for possible connection to an ongoing criminal case or to a case on file. Local law enforcement within the jurisdiction of the crime is contacted; social security numbers, addresses, and other personal information will be verified, and then crosschecked with information on file in the database. A Crime Alert will then be sent simultaneous by fax or by e-mail to our Network Members either in a given city or state or member category where the crime took place. Local law enforcement in the surrounding areas will also receive a criminal profile referral, which will include all data on file relating to the crime.

Another shortcoming of the methods taught in the prior art is that they fail to allow both residents and businesses to participate and provide contact information.

Still another shortcoming of the prior art advertising methods it they fail to provide law enforcement with adequate means to offer and manage a neighborhood crime watch group.

Yet another shortcoming is that the prior art does not disclose or utilize an effective means of database querying and information dissemination.

### SUMMARY OF THE INVENTION

A system and method that allows Law enforcement to communicate quickly and efficiently with businesses, business owners, resident or homeowners. Businesses or residents first create a profile at a website. The profile includes address, contact information, secondary contact information, alarm company name and number and information about the type of business. Law Enforcement has the ability to send email, fax or electronic messages (like text messages to cell phones) alerting businesses, their owners & their employees or residents about crime that affects them. Law Enforcement can select different types of businesses, businesses within a certain range or businesses that have certain characteristics, like handle a lot of cash. Additionally they have the ability to look up information about a specific business, for example at three AM when the window is broken, and they need someone to come take care of the mess, or retrieve information about a group of businesses, like the names and numbers of all pawn shops within five miles. There is a Business Watch feature that is built in, and a series of Business Watch features that can be added.

It is an objective of the present invention that allows both residents and businesses to participate and provide contact information.

In addition, it is the objective to provide law enforcement with adequate means to offer and manage a neighborhood crime watch group.

It is another objective to teach and utilize an effective means of database querying and information dissemination.

### BRIEF DESCRIPTION OF THE DRAWINGS

The accompanying drawings, which are incorporated herein and form a part of the specification, illustrate the present invention and, together with the description, further serve to explain the principles of the invention and to enable a person skilled in the pertinent art to make and use the invention.

FIG. 1 is a flow chart illustrating the registration process for a business with the system of the present invention;

FIG. 2 is a flow chart illustrating how a law enforcement office such as a Detective can use the system of the present invention;

FIG. 3 is a flow chart illustrating the registration process for an individual or resident with the system of the present invention; and

FIG. 4 is a flow chart illustrating the

### DETAILED DESCRIPTION OF THE INVENTION

In the following detailed description of the invention of exemplary embodiments of the invention, reference is made to the accompanying drawings (where like numbers represent like elements), which form a part hereof, and in which is shown by way of illustration specific exemplary embodiments in which the invention may be practiced. These embodiments are described in sufficient detail to enable those skilled in the art to practice the invention, but other embodiments may be utilized and logical, mechanical, electrical, and other changes may be made without departing from the scope of the present invention. The following detailed description is, therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, well-known structures and techniques known to one of ordinary skill in the art have not been shown in detail in order not to obscure the invention.

Referring to the figures, it is possible to see the various major elements constituting the apparatus of the present invention. The present invention is a system and method that allows Law enforcement to communicate quickly and efficiently with businesses and business owners and logs activity.

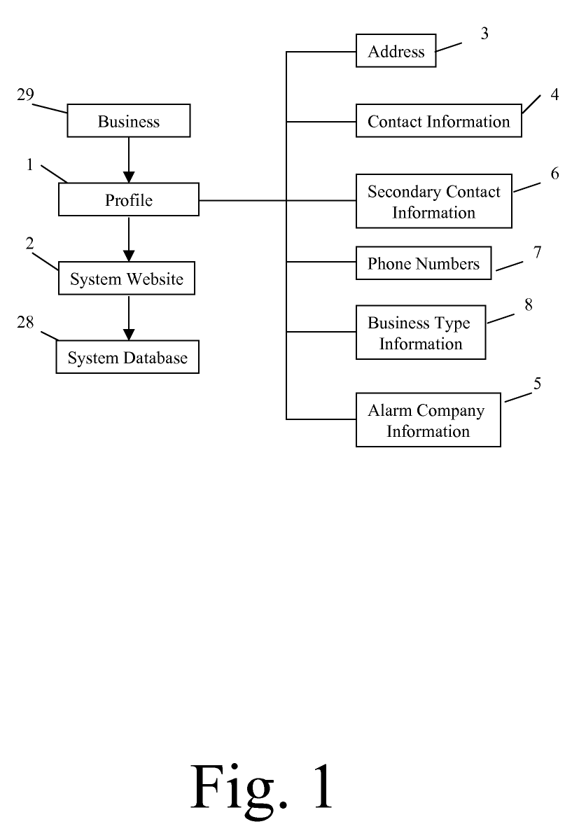

Now referring to FIG. 1, Businesses 29 first create a profile 1 at a system website 2 that is stored in a system database 28. The profile 1 includes address 3, contact information 4, secondary contact information 6, alarm company information 5 and Telephone numbers 7 and information about the type of business 8.

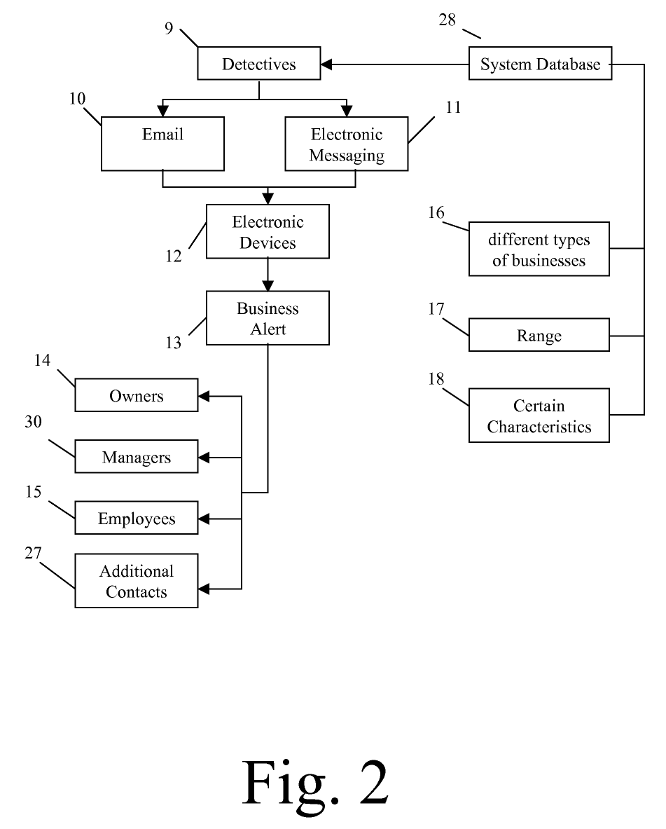

Now referring to FIG. 2, Detectives or law enforcement 9 have the ability to send email 10 and electronic messaging (like fax, text or pre-recorded phone messages) 11 to communication devices 12 alerting businesses 13, their owners 14, their managers 30, employees 15, and additional contacts 27 about crime that affects them. Detectives 9 can select different types of businesses 16, businesses within a certain range 17 or businesses that have certain characteristics 18, like handle a lot of cash. Messages can be emailed, faxed, or sent as any electronic text message known in the prior art as the system includes a software engine that uses templates to convert messages into electronic form for dissemination. Messages are reviewed by a supervisor for approval to be disseminated.

Detectives 9 have the ability to add individuals, businesses, and households that are unable to self-register with the system. Detectives can also add other users such as media outlets like radio stations, television stations, reporters, as well as other law enforcement agencies and private law enforcement and security organizations such as college campus security, mall security, park security, bus companies, train companies, and schools. Being able to disseminate messages to such a broad range of users allows the users of the system to send Amber alerts to law enforcement agencies and schools or other locations or send our warnings of local crime to small communities or parts of a large city by using a simple database filter to determine dissemination lists. Other database filters can be used to create dissemination lists based on radius from a crime, areas, communities, or specific business characteristics.

Additionally, Detectives 9 have the ability to look up information about a specific business, for example at three AM when the window is broken, and they need someone to come take care of the mess, or retrieve information about a group of businesses like the names and numbers of all pawn shops within five miles.

There is a Business Watch feature that is built in, and a series of Business Watch features that can be added.

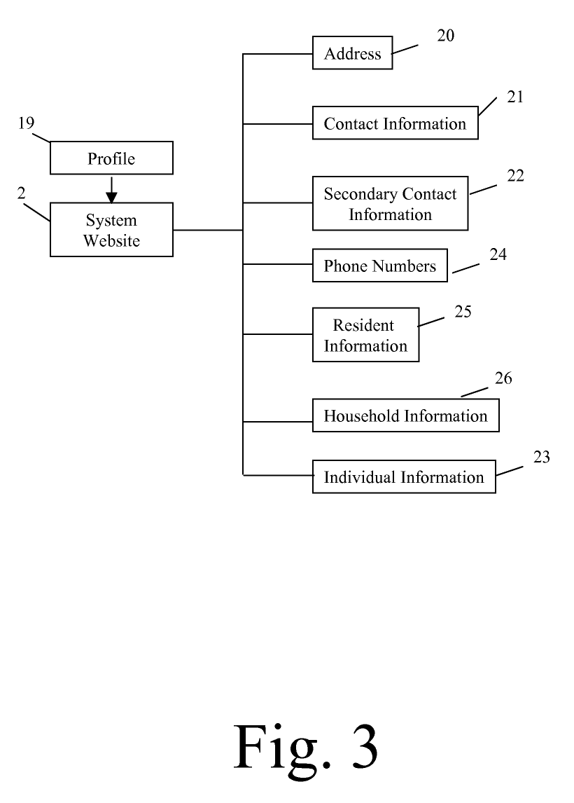

Now referring to FIG. 3, residents, households, and individuals can create a profile 19 at a system website 2. The profile 19 includes address 20, contact information 21, secondary contact information 22, numbers 24, and information about resident 25, households 26, and individuals 23. Residents can enter additional household resident and individuals into the system database.

A neighborhood watch feature can be included in an alternative embodiment of the present invention. Detectives can access or query specific lists of people by an identification tag, name or address. Also, by incorporating authority levels in the system, registrants can be granted restricted access to create virtual neighborhood groups that can be managed by a neighborhood captain who can view current criminal activity and send limited messages to select groups or users.

The system enables a virtual neighborhood watch and reduces the most common problems that lead to failure with neighborhood watch programs and their interaction with local law enforcement. The most common problems that lead to failure are, overworked block captains, loss of a block captain, management and administrative work, changes in the community as residents leave and enter the community, and the creation of reports, specific lists and dissemination of information. The system of the present invention provides means for sending targeted messages. For example, if a bike is stolen in a community, a block captain could use the system of the present invention to send a report of the criminal activity to the members of the neighborhood and also send a report to members within a given geographic radius surrounding the area of the criminal activity so that they can be on the lookout for the stolen property and can be empowered to take action against criminal activity.

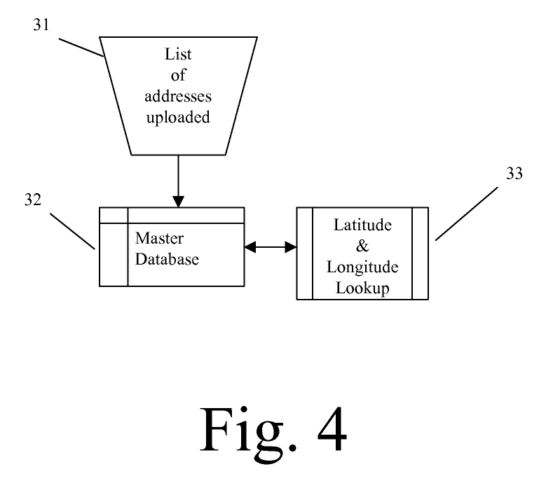

Now referring to FIG. 4, City uploads list of addresses 31 (all or part) both commercial and residential to a master database 32. Addresses are cross-referenced with Latitude and Longitude (for mapping) 33. A Crime Watch Administrator (‘CWA’) then has the ability to assign addresses to a particular Watch (smaller group of residents or businesses that watch out for each other). The Crime Watch Administrator can assign various positions within the watch, but most importantly a ‘Captain’ who will administer the Watch. The Crime Watch Administrator can reassign Captain as needed.

Residents/Businesses can signup/logon and input their information (names, address, phone numbers, emails addresses, etc.), which will match up against the Master Address Database 32. If it matches, it will be pending approval of the Captain or CWA. If there is no watch covering this address, resident/Business asked if they wish to establish one and assist in getting it started. As owners/tenants change, new information is added and the old information is added to a history for the address. Any change requires CWA/Captain approval.

Once a particular ‘Watch’ is established, the Captain will have ability to publish and distribute (Print, email, etc.) lists of names and contact information to members of the watch. Watch members can communicate with all members of their watch. The Captain and CWA have ability to restrict communication if needed. Watch Captains have ability to communicate with surrounding watches in CWA defined radius. Law Enforcement and CWA has ability to lookup and communicate with all. Communication is via method already defined.

Thus, it is appreciated that the optimum dimensional relationships for the parts of the invention, to include variation in size, materials, shape, form, function, and manner of operation, assembly and use, are deemed readily apparent and obvious to one of ordinary skill in the art, and all equivalent relationships to those illustrated in the drawings and described in the above description are intended to be encompassed by the present invention.

Furthermore, other areas of art may benefit from this method and adjustments to the design are anticipated. Thus, the scope of the invention should be determined by the appended claims and their legal equivalents, rather than by the examples given.

The embodiments of the invention in which an exclusive property or privilege is claimed are defined as follows:

1. A method for monitoring crime activity and dissemination of crime related information and alerts over a multi-user network, comprising the steps of:
recording business information;
creating a business profile;
disseminating communication to electronic devices; and
alerting businesses about criminal activity.

2. The method of claim 1 wherein the business profile includes address, contact information, secondary contact information, alarm company name and number and information about the type of business.

3. The method of claim 1 wherein emails and text messages are disseminated to the cell phones of businesses owners and employees about criminal activity.

4. The method of claim 1 wherein emails and text messages are disseminated to businesses within a certain range.

5. The method of claim 1 wherein emails and text messages are disseminated to businesses with specific profile characteristics.

6. The method of claim 1, further comprising the step of querying information about a specific business.

7. The method of claim 1, further comprising the step of retrieving information about a group of businesses.

8. A system for monitoring crime activity and dissemination of crime related information and alerts over a multi-user network, comprising
means for providing a graphical user interface to navigate a website, said website further comprising;
means for recording business information;
means for creating a business profile;
means for creating targeted messages; and
means for disseminating emails and electronic messages to electronic devices (like cell phones, pre-recorded message delivery services and fax machines)—alerting businesses about criminal activity.

9. The system of claim 8, further comprising means for storing profile information including: address, contact information, secondary contact information, alarm company name and number and information about the type of business.

10. The system of claim 8, further comprising means for disseminating emails and electronic messaging to the electronic devices of businesses owners and employees about criminal activity

11. The system of claim 8, further comprising means for disseminating emails and text messages to businesses within a certain range.

12. The system of claim 8, further comprising means for disseminating emails and text messages to businesses with specific profile characteristics.

13. The system of claim 8, further comprising means for querying information about a specific business.

14. The system of claim 8, further comprising means for retrieving information about a group of businesses.

15. The system of claim 8, further comprising means for residents, households, and individuals to create a profile wherein the profile includes address, contact information, secondary contact information, numbers, and information about residents, households, additional household residents, and individuals.

16. The system of claim 8, further comprising:
means for accessing and querying specific lists of people by an identification tag, name or address for creating neighborhood watch groups;
means for incorporating authority levels in the system so that registrants can be granted restricted access to create virtual neighborhood groups that can be managed by a neighborhood captain who can view current criminal activity; and
means for disseminating limited messages to select groups or users.

17. The method of claim 1, further comprising the steps of creating a profile for residents, households, and individuals wherein the profile includes address, contact information, secondary contact information, numbers, and information about residents, households, additional household residents, and individuals.

18. The method of claim 1, further comprising the steps of:
accessing and querying specific lists of people by an identification tag, name or address for creating neighborhood watch groups;
incorporating authority levels in the system so that registrants can be granted restricted access to create virtual neighborhood groups that can be managed by a neighborhood captain who can view current criminal activity; and
disseminating limited messages to select groups or users.

19. The method of claim 1, further comprising the steps of:
uploading lists of addresses to a master database;
cross-referencing addresses with latitude and longitude for map generation;
appointing a crime watch administrator with the ability to assign addresses to a particular watch group;
assigning various positions within the watch, including a Captain who will administer the watch;
singing up residents and businesses;
matching residents and businesses up against the master address database to assign a watch group;
publishing and distributing lists of names and contact information to members of the watch wherein watch members can communicate with all members of their watch.

20. The method of claim 1, wherein
the watch captain and crime watch administrator have ability to restrict communication if needed;
watch captains have ability to communicate with surrounding watches in crime watch administrator defined radius; and
law enforcement and the crime watch administrator can lookup and communicate with all parties.
